(19) United States
(12) Patent Application Publication
(10) Pub. No.: US 2026/0037174 A1
(43) Pub. Date: Feb. 5, 2026

(54) Method for Optimizing Memory Access Based on Machine Learning Model and Related Device

(71) Applicant: MEDIATEK INC., Hsin-Chu (TW)

(72) Inventors: Meng-Hsuan Yang, Hsinchu City (TW); Yu-Chen Lin, Hsinchu City (TW); Hsing-Chang Chou, Hsinchu City (TW); Po-Hua Huang, Hsinchu City (TW)

(73) Assignee: MEDIATEK INC., Hsin-Chu (TW)

(21) Appl. No.: 18/793,937

(22) Filed: Aug. 4, 2024

(51) Int. Cl. G06F 3/06

(52) U.S. Cl. CPC G06F 3/0655; G06F 3/0604; G06F 3/0673

(57) ABSTRACT

A method for optimizing memory access based on a machine learning model is provided. The method includes converting a portion of the machine learning model corresponding to an operation requirement of a hardware into a directed acyclic graph, wherein the portion of the machine learning model comprises multiple fusions, and the directed acyclic graph comprises a plurality of vertexes and a plurality of directed edges, wherein the edge e_{i,j} is the edge from the vertex Vᵢ to vertex Vⱼ, and the value of the edge e_{i,j} is set to indicate a total amount of DRAM accesses from an input of fusionᵢ to an output of fusionⱼ₋₁, and, where i, j are positive integers and j is larger than i; and determining a shortest path, wherein the shortest path represents the path from a starting vertex to a destination vertex with a smallest total amount of DRAM accesses.

### BACKGROUND

In recent years, there have been more and more artificial intelligence (AI) applications on mobile phones, and many applications are always kept running while the mobile phone is turned on. Therefore, performance and power consumption are the focus of many mobile phone manufacturers. In order to minimize power consumption, reducing dynamic random access memory (DRAM) accesses and increasing cache accesses have become an essential issue for mobile phone manufacturers.

Accelerated processing unit (APU) is the core chip used to manage and execute the built-in functions of modern “smart” devices. In fact, as more and more consumer devices are always on and connected, APUs are an ideal alternative to their traditionally more power-hungry x86 products. In order to save the power consumption of APUs, the access to external memory such as dynamic random access memory (DRAM) is reduced by using cache instead. Therefore, a method is needed to reduce the amount of the external memory access of the APU.

### SUMMARY

A method for optimizing memory access is provided. The method includes converting a portion of a machine learning model corresponding to an operation requirement of a hardware into a directed acyclic graph, wherein the portion of the machine learning model comprises multiple fusions, and the directed acyclic graph comprises a plurality of vertexes and a plurality of directed edges, wherein the edge e_{i,j} is the edge from the vertex Vᵢ to vertex Vⱼ, and the value of the edge e_{i,j} is set to indicate a total amount of an external memory accesses from an input of fusionᵢ to an output of fusionⱼ₋₁, and, where i, j are positive integers and j is larger than i, and wherein the external memory is located outside of the hardware; and determining a shortest path, wherein the shortest path represents the path from a starting vertex to a destination vertex with a smallest total amount of DRAM accesses, wherein the staring vertex does not have an input edge, and the destination vertex does not have an output edge. The external memory is located outside of the hardware.

A device is provided. The device includes a processor and a memory. The memory is used for storing instructions, wherein the instructions are performed by the processor to perform operations: convert a portion of a machine learning model corresponding to an operation requirement of a hardware into a directed acyclic graph, wherein the portion of the machine learning model comprises multiple fusions, and the directed acyclic graph comprises a plurality of vertices and a plurality of directed edges, wherein an edge e_{i,j} is from a vertex Vᵢ to a vertex Vⱼ, and a value of the edge e_{i,j} is set to indicate a total amount of an external memory accesses from an input of fusionᵢ to an output of fusionⱼ₋₁, where i, j are positive integers and j is larger than i, and wherein the external memory is located outside of the hardware; and determine a shortest path, wherein the shortest path is from a starting vertex to a destination vertex with a smallest total amount of external memory accesses, wherein the starting vertex does not have an input edge, and the destination vertex does not have an output edge. The external memory may be DRAM.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a portion of machine learning model corresponding to operations of hardware according to an embodiment of the present invention.

FIG. 1B is a device for optimizing memory access based on the machine learning model according to an embodiment of the present invention.

FIG. 1C is a system for optimizing memory access based on the machine learning model according to an embodiment of the present invention.

FIG. 2 is the flowchart of a method for optimizing memory access according to an embodiment of the present invention.

FIG. 3 is a flowchart for a method of forming a directed acyclic graph according to an embodiment of the present invention.

FIG. 4 is a directed acyclic graph transformed from a portion of the machine learning model according to an embodiment of the present invention.

FIG. 5 is the flowchart of a topological sorting method for the shortest path problem of the directed acyclic graph according to an embodiment of the present invention.

FIG. 6 is an initialized directed acyclic graph according to an embodiment of the present invention.

FIG. 7 is a result of using topological sorting to determine the shortest problem of the directed acyclic graph according to an embodiment of the present invention.

### DETAILED DESCRIPTION

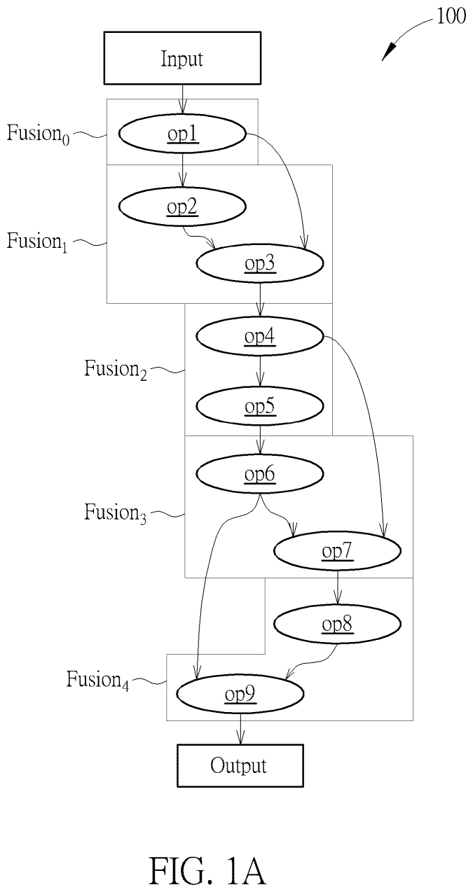

FIG. 1A is a portion of machine learning model 100 corresponding to operations of a hardware according to an embodiment of the present invention. The portion of machine learning model 100 may describe the operations performed by the hardware and the access to DRAM and/or SRAM for the input and/or output of these operations. The hardware may perform these operations using supported hardware instructions, store the outputs of the operations into DRAM or SRAM and read the inputs of the operations from DRAM or SRAM.

The machine learning model may include a plurality of fusions. Each fusion comprises one or more operations. Operation(s) in the same fusion can be performed by the hardware without accessing DRAM. The tensor transferred between two operations in the machine learning model represents the data transferred between two operations in the hardware. The data transferred between two operations in one fusion in the hardware may be stored in a Static Random Access Memory (SRAM). The data transferred between two operations in different fusions in the hardware may be stored in a Dynamic Random Access Memory (DRAM). As shown in FIG. 1A, an arrow between different fusions in machine learning model represents that the data transferred between two operations in different fusions in the hardware may be stored in the DRAM, and an arrow in the same fusion in machine learning model represents that the data transferred between two operations in the same fusion in the hardware may be stored in the SRAM.

As shown in FIG. 1A, the machine learning model 100 comprises 5 fusions. Fusion₀ includes operation op1. Fusion₁ includes operations op2 and operation op3. Fusion₂ includes operation op4 and operation op5. Fusion₃ includes operation op6 and operation op7. Fusion₄ includes operation op8 and operation op9. The arrow between different fusions may represent an access to the DRAM, and the arrow in the same fusion may represent an access to the SRAM. For example, the arrows between Fusion₀ and Fusion₁ represent that data output from operation op1 in the Fusion₀ is stored in the DRAM, and operation op2 in the Fusion₁ and operation op3 in the Fusion may read the data from the DRAM. The arrow in the Fusion₁ represents that data output from operation op2 in the Fusion₁ to operation op3 in the Fusion₁ is stored in the SRAM. For Fusion₀, the input data is read from the DRAM, and the output data is written into the DRAM. Therefore, for Fusion₀, the number of DRAM access is two. Similarly, for Fusion₁, the number of DRAM access is three. For fusion₂, the number of DRAM access is three.

Furthermore, the total data amount of DRAM access can be obtained for a single fusion. Specifically, the total data amount of DRAM access can be obtained based on the number of readings required by the fusion to read DRAM and the number of bytes each time it reads, and the number of writings required by the fusion to write into DRAM and the number of bytes each time it writes.

FIG. 1B is a device for optimizing memory access based on machine learning model according to an embodiment of the present invention. The device 102 includes a processor 104 and a memory 106. The memory 106 is used for storing instructions, wherein the instructions are performed by the processor 104 to perform operations: convert a portion of a machine learning model corresponding to an operation requirement of a hardware into a directed acyclic graph, wherein the portion of the machine learning model comprises multiple fusions, and the directed acyclic graph comprises a plurality of vertices and a plurality of directed edges, wherein an edge e_{i,j} is from a vertex Vᵢ to a vertex Vⱼ, and a value of the edge e_{i,j} is set to indicate a total amount of an external memory accesses from an input of fusionᵢ to an output of fusionⱼ₋₁, where i, j are positive integers and j is larger than i, and wherein the external memory is located outside of the hardware and the external memory may be DRAM; and determine a shortest path, wherein the shortest path is from a starting vertex to a destination vertex with a smallest total amount of external memory accesses, wherein the starting vertex does not have an input edge, and the destination vertex does not have an output edge.

An edge e_{i,j} is from a vertex Vᵢ to a vertex Vⱼ, and a value of the edge e_{i,j} is set to indicate a total amount of DRAM accesses from an input of fusionᵢ to an output of fusionⱼ₋₁, where i, j are positive integers and j is larger than i. The total amount of DRAM accesses from an input of fusionᵢ to an output of fusionⱼ₋₁ includes: the amount of DRAM access required for the input of fusionᵢ and the amount of DRAM access required for the output of fusionⱼ₋₁. If fusionᵢ has a plurality of inputs and the operation requirement of the hardware need the plurality of inputs of fusionᵢ, the total amount of DRAM accesses from an input of fusionᵢ to an output of fusionⱼ₋₁ may include the amount of DRAM access required for the plurality of inputs of fusionᵢ. If fusionⱼ₋₁ has a plurality of outputs and the operation requirement of the hardware need the plurality of outputs of fusionⱼ₋₁, the total amount of DRAM accesses from an input of fusionᵢ to an output of fusionⱼ₋₁ may include the amount of DRAM access required for the plurality of outputs of fusionⱼ₋₁. When j−1 is large than i, the edge e_{i,j} may also implicitly indicate the data that needs to be transferred between the fusions in a fusion set from fusionᵢ to fusionⱼ₋₁ is stored in the cache, rather than the DRAM.

FIG. 1C is a system for optimizing memory access based on machine learning model according to an embodiment of the present invention. The system 108 comprises a processor 110, a hardware 112 and a DRAM 114. The hardware may be an APU. The processor is configured to convert a portion of a machine learning model corresponding to an operation requirement of the hardware into a directed acyclic graph, wherein the portion of the machine learning model comprises multiple fusions, and the directed acyclic graph comprises a plurality of vertices and a plurality of directed edges, wherein an edge e_{i,j} is from a vertex Vᵢ to a vertex Vⱼ, and a value of the edge e_{i,j} is set to indicate a total amount of a DRAM accesses from an input of fusionᵢ to an output of fusionⱼ₋₁, where i, j are positive integers and j is larger than i, and determine a shortest path and output information of the shortest path, wherein the shortest path is from a starting vertex to a destination vertex with a smallest total amount of DRAM accesses, wherein the starting vertex does not have an input edge, and the destination vertex does not have an output edge. The hardware is configured to perform operations and access the DRAM according to the information of the shortest path.

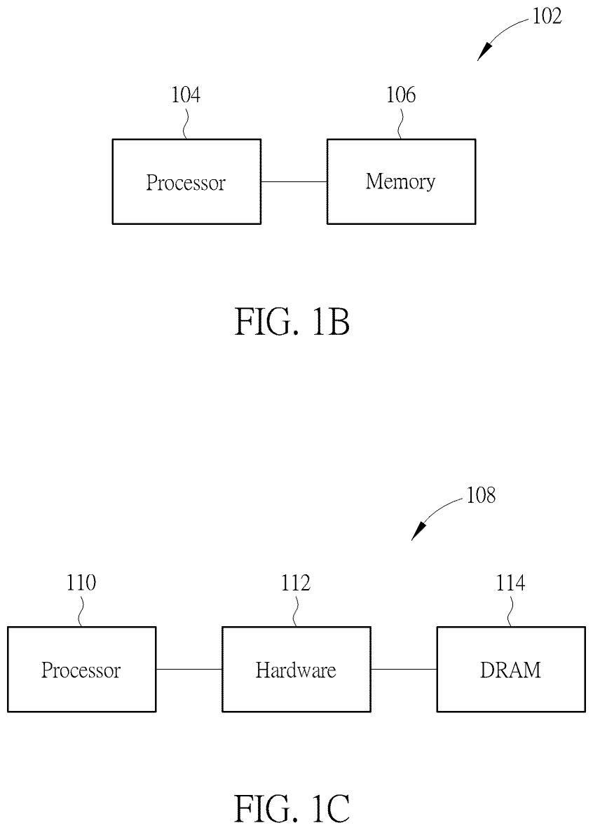

FIG. 2 is the flowchart of a method 200 for optimizing memory access according to an embodiment of the present invention. The method 200 for optimizing memory access may include the following steps:

Step S202: form the machine learning model; wherein the machine learning model comprises multiple fusions, each fusion comprises one or more operations. The machine learning model may be a deep neural network (DNN) model. An example of a portion of the machine learning model 100 can be shown in FIG. 1A.

Step S204: convert a portion of the machine learning model corresponding to an operation requirement of the hardware into a directed acyclic graph. The portion of the machine learning model comprises multiple fusions. The directed acyclic graph comprises a plurality of vertices and a plurality of directed edges, wherein the edge e_{i,j} is the edge from the vertex Vᵢ to vertex Vⱼ, the value of the edge e_{i,j} is set to indicate a total amount of DRAM accesses from an input of fusionᵢ to an output of fusionⱼ₋₁, and, wherein i, j are positive integers and j is larger than i. The total amount of DRAM accesses from an input of fusion; to an output of fusionⱼ₋₁ includes: the amount of DRAM access required for the input of fusionᵢ and the amount of DRAM access required for the output of fusionⱼ₋₁. When j−1 is large than i, the edge e_{i,j} may also implicitly indicate the data that needs to be transferred between the fusions in a fusion set from fusionᵢ to fusionⱼ₋₁ is stored in the cache, rather than the DRAM.

Step S206: determine a shortest path, wherein the shortest path represents the path from a starting vertex to a destination vertex with the smallest total amount of DRAM accesses, wherein the starting vertex does not have an input edge, and the destination vertex does not have an output edge.

The total amount of DRAM accesses may be the total data amount of DRAM accesses. The total data amount of DRAM accesses may be obtained based on the number of the DRAM access and the number of bytes each time the hardware accesses the DRAM.

The shortest path may represent the path from the starting vertex to the destination vertex on which the sum of the total data amount of DRAM access indicated by the edges in the path is smallest. In one embodiment, the shortest path may be determined by a topological sorting method. It will be appreciated by those skilled in the art that the shortest path may also be determined by other methods, and the present application is not limited to the topological sorting method.

Since the shortest path of the directed acyclic graph is determined, the edges included in the shortest path can be determined, wherein the edge corresponds to the data amount of DRAM access by the hardware. Therefore, a path with the least data amount of DRAM access by the hardware is determined based on the shortest path of the directed acyclic graph. Furthermore, the edge in the shortest path can reflect whether the data that needs to be transferred between different fusions is stored in a DRAM or a cache. Based on the path with the least data amount of DRAM accesses, the hardware may store some data transferred between different fusions in the cache, reducing the access to DRAM.

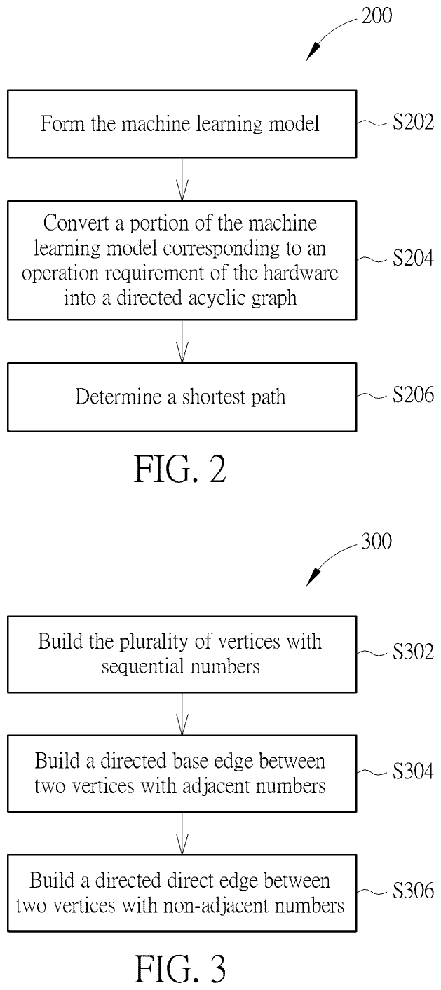

FIG. 3 is a flowchart for a method 300 of forming a directed acyclic graph according to an embodiment of the present invention. The method includes the following steps:
Step S302: build the plurality of vertices with sequential numbers, wherein the number of the vertices is equal to the number of fusions in the portion of the machine learning model plus one;
Step S304: build a directed base edge between two vertices with adjacent numbers, wherein the directed base edge is set to indicate a total amount of DRAM accesses of the corresponding single fusion. The total amount of DRAM accesses of the corresponding single fusion may be the data total amount of DRAM accesses of the corresponding single fusion.
Step S306: build a directed direct edge between two vertices with non-adjacent numbers, wherein the directed direct edge is set to indicate a total amount of DRAM accesses from an input of one fusion to an output of another fusion, and the data that needs to be transferred between the fusions in a fusion set from the one fusion to another fusion is stored in the cache. It is noted that whether a directed direct edge is built is based on the capacity of the cache. Specifically, if the cache has the capacity to store the data that needs to be transferred between the fusions in a fusion set from one fusion to another fusion, then the directed direct edge is built. If the cache does not have the capacity to store the data that needs to be transferred between the fusions in a fusion set from one fusion to another fusion, then the directed direct edge is not built.

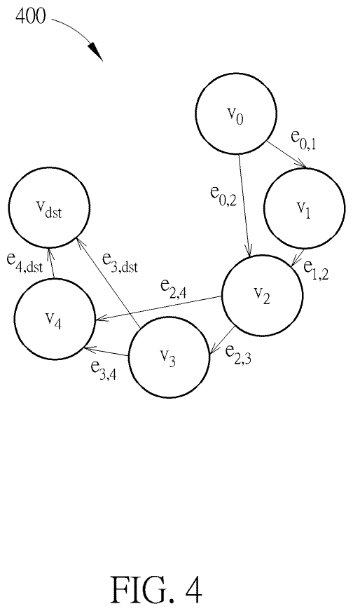

FIG. 4 is a directed acyclic graph 400 transformed from a portion of the machine learning model 100 according to an embodiment of the present invention. In order to transform the portion of the machine learning model 100 to a directed acyclic graph 400, vertices Vᵢ, V_{dst} and edges e_{i,j} are established. The edges e_{i,j} are directed and established from Vᵢ to Vⱼ. The value of the edges e_{i,j} are set to indicate the total data amount of DRAM accesses from an input of fusionᵢ to an output of fusionⱼ₋₁. The initialization is performed to set the value of vertex V₀ as 0 and the values of vertices Vᵢ and V_{dst} as large values.

At first, link vertices V₀ and Vᵢ with edge e_{0,1}, link vertices V₁ and V₂ with edge e_{1,2}, link vertices V₂ and V₃ with edge e_{2,3}, link vertices V₃ and V₄ with edge e_{3,4}, and link vertices V₄ and V_{dst} with edge e_{4,dst} when dst=5. The value of edge e_{0,1} is set to indicate the total data amount of DRAM accesses of fusion₀, the value of edge e_{1,2} is set to indicate the total data amount of DRAM accesses of fusion₁, the value of the edge e_{2,3} is set to indicate the total data amount of DRAM accesses of fusion₂, the value of the edge e_{3,4} is set to indicate the total data amount of DRAM accesses of fusions, and the value of the edge e_{4,dst} is set to indicate the total amount of DRAM accesses of fusion₄.

Then, since the cache has a large available space to store the data output from the operation op1 in fusion₀ to the inputs of operation op2 and operation op3 in fusionᵢ, edge e_{0,2} is drawn in the directed acyclic graph 400 to link vertices V₀ and V₂, for indicating the total data amount of DRAM access from the input of fusion₀ to the output of the fusion₁. Since the cache has a large available space to store the data output from the operation op4 in fusion₂ to the operation op7 in fusion₃ and the data output from the operation op5 in fusion₂ to the operation op6 in fusion₃, edge e_{2,4} is drawn in the directed acyclic graph 400 to link vertices V₂ and V₄, for indicating the total data amount of DRAM access from the input of fusion₂ to the output of the fusion₃. Since the cache has a large available space to store the data output from the operation op6 in fusion₃ to the operation op9 in fusion₄ and the data output from the operation op7 in fusion₃ to the operation op8 in fusion₄, e_{3,dst} is drawn in the directed acyclic graph 400 to link vertices V₃ and V_{dst}, for indicating the total data amount of DRAM access from the input of fusion₃ to the output of the fusion₄.

In this way, the problem of method 200 for optimizing memory access using the machine learning model 100 can be fully transformed into a shortest path problem of the directed acyclic graph 400. Minimizing the usage of DRAM is realized by finding a shortest path from vertex V₀ to vertex V_{dst}.

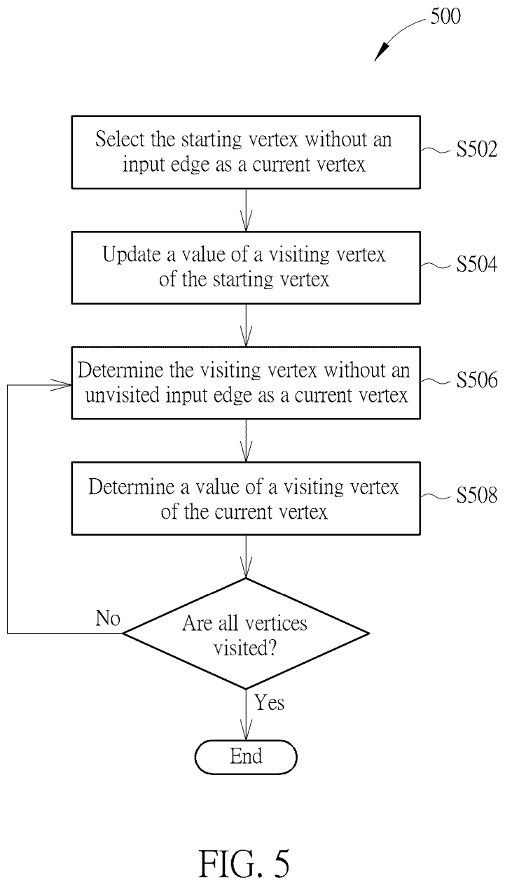

FIG. 5 is the flowchart of a topological sorting method 500 for the shortest path problem of the directed cyclic graph 400 according to an embodiment of the present invention. The topological sorting method 500 may include the following steps:
Step S502: Select the start vertex without an input edge as a current vertex. The initial value of the starting vertex is set to 0 and the initial value of the non-starting vertex is set to a large value.
Step S504: Update a value of a visiting vertex of the starting vertex. The visiting vertex is connected to the starting vertex through an output edge of the starting vertex. The value of the visiting vertex equals to the value of the edge from the starting vertex to the visiting vertex.
Step S506: Determine the visiting vertex without an unvisited input edge as a current vertex.
Step S508: Determine a value of a visiting vertex of the current vertex, wherein the visiting vertex is connected to the current vertex through an output edge of the current vertex. The value of the vertex Vi may indicate the total data amount of DRAM access from the input of fusion0 to the output of fusioni−1. Repeat the step S506 and S508 until all vertices have been visited and there are no unvisited edges.

Specifically, add the value of the edge from the current vertex to the visiting vertex and a current value of the current vertex to obtain a sum value; update the current value of the visiting vertex to the sum value if the sum value is smaller than the current value of the visiting vertex; keep the current value of the visiting vertex unchanged if the sum value is not smaller than the current value of the visiting vertex.

To finish the topological sorting, all vertices must be visited and there are no unvisited edges. A path with the minimum total data amount of DRAM accesses leading to the destination vertex without an output edge (for example, V_{dst} in FIG. 4) is selected for the portion of machine learning model 100. That is, the path with the minimum total data amount of DRAM accesses from start vertex V₀ to destination vertex V_{dst} in FIG. 4 is the solution to the shortest path problem of the topological sorting.

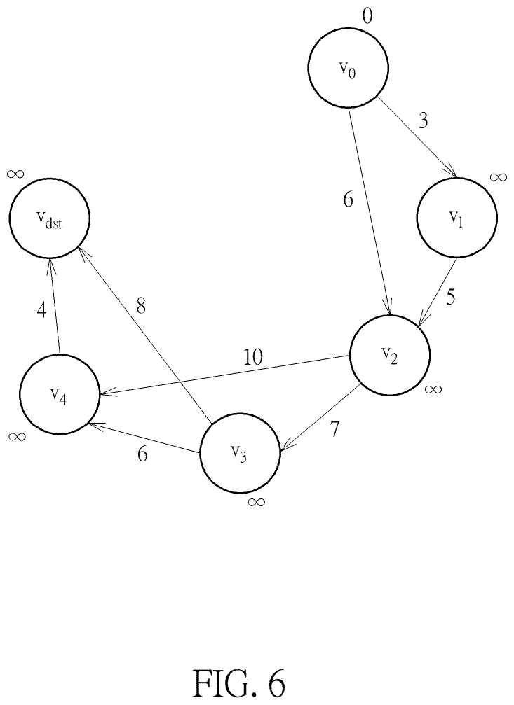

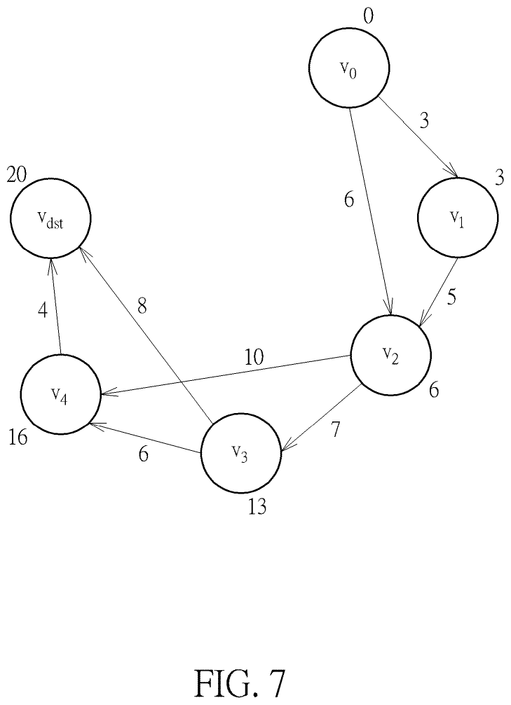

FIG. 6 is an initialized directed acyclic graph 600 according to an embodiment of the present invention. FIG. 7 is a result of using topological sorting to determine the shortest path problem of the directed acyclic graph 700 according to an embodiment of the present invention. In FIG. 6, the value of edge e_{0,1} is 3, the value of edge e_{1,2} is 5, the value of edge e_{2,3} is 7, the value of edge e_{3,4} is 6, the value of edge e_{4,dst} is 4, the value of edge e_{0,2} is 6, the value of edge e_{2,4} is 10, and the value of edge e_{3,dst} is 8. The initial value of vertex V₀ is 0, vertices Vᵢ and V_{dst} are set as large values illustrated with an infinity sign as shown in FIG. 6.

At first, vertex V₀ is selected. The visiting vertex of V₀ are vertices Vᵢ and V₂. For vertex V₁, because edge e_{0,1} is the only path leading to vertex V₁, the value of vertex V₁ is updated to be 3 as shown in FIG. 7. For vertex V₂, because the value of edge e_{0,2} is 6, the value of vertex V₂ is 6.

Next, the current vertex becomes vertex V₁ because there is no unvisited input edge to vertex V₁. The visiting vertex of vertex V₁ is vertex V₂, and the value of the path leading to vertex V₂ from vertex V₀ through vertex V₁ is 8 because the value of edge e_{0,1} is 3 and the value of edge e_{1,2} is 5. However, the value of the path directly from vertex V₀ to vertex V₂ is 6 which is smaller than 8. Therefore, the value of vertex V₂ remains to be 6 as shown in FIG. 7.

Then, the current vertex becomes vertex V₂ because there is no unvisited input edge to vertex V₂, and the visiting vertices of vertex V₂ are vertices V₃ and V₄. The value of vertices V₃ and V₄ are updated to be 13 and 16 respectively as shown in FIG. 7 because the edge e_{2,3} is 7 and the edge e_{2,4} is 10. Then, the current vertex becomes vertex V₃, and the visiting vertices become V₄ and V_{dst}.

The value of vertex V_{dst} is updated to be 21 because the value of edge e_{3,dst} is 8 and value of vertex V₃ is 13. For vertex V₄, the current value is 16, and there is unvisited edge e_{3,4}. The value of Vertex V₄ caused by the unvisited edge e_{3,4} is equal to the value of the unvisited edge e_{3,4} add the value of Vertex V₃. Because the value of Vertex V₄ caused by the unvisited edge e_{3,4} is 19 and larger than 16, the value of vertex V₄ remains to be 16 as shown in FIG. 7. The unvisited edge e_{3,4} becomes the visited edge.

Then, the current vertex becomes vertex V₄, and the visiting vertex becomes vertex V_{dst}. For vertex V_{dst}, the current value is 21, and there is unvisited edge e_{4,dst}. The value of Vertex V_{dst} caused by the unvisited edge e_{4,dst} is equal to the value of the unvisited edge e_{4,dst} plus the value of Vertex V₄. The value of Vertex V_{dst} caused by the unvisited edge e_{4,dst} is 20. Because the value of Vertex V_{dst} caused by the unvisited edge e_{4,dst} is smaller than 21, the value of vertex V_{dst} is updated to be 20 as shown in FIG. 7. The unvisited edge e_{4,dst} becomes the visited edge.

Thus, the topological sorting is completed and the shortest path problem of the directed acyclic graph 400 is solved by selecting the path with the minimum data amount of DRAM accesses. That is, the path linked by edges e_{0,2}, e_{2,4}, and e_{4,dst}, from vertex V₀ through vertices V₂ and V₄ to vertex V_{dst}.

By applying the topological sorting on the shortest path problem of the directed acyclic graph 400, a path of minimum data amount of DRAM accesses can be found and thus solving the problem of optimizing DRAM access for deep neural network (DNN). Based on the path of minimum data amount of DRAM accesses, the hardware may store some data transferred between different fusions in the cache, reducing the access to DRAM.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for optimizing memory access, comprising:
converting a portion of a machine learning model corresponding to an operation requirement of a hardware into a directed acyclic graph; wherein the portion of the machine learning model comprises multiple fusions, and the directed acyclic graph comprises a plurality of vertexes and a plurality of directed edges,
wherein the edge e_{i,j} is the edge from the vertex Vᵢ to vertex Vⱼ, and the value of the edge e_{i,j} is set to indicate a total amount of an external memory access from an input of fusionᵢ to an output of fusionⱼ₋₁, and, wherein i, j are positive integers and j is larger than i, and wherein the external memory is located outside of the hardware; and
determining a shortest path, wherein the shortest path represents the path from a starting vertex to a destination vertex with a smallest total amount of external memory accesses, wherein the staring vertex does not have an input edge, and the destination vertex does not have an output edge.

2. The method of claim 1, wherein, the edge e_{i,j} is used for indicating the data that needs to be transferred between the fusions in a fusion set from fusionᵢ to fusionⱼ₋₁ is stored in a cache, rather than the external memory, when j−1 is larger than i.

3. The method of claim 1, wherein the external memory is a DRAM (dynamic random access memory).

4. The method of claim 1, wherein the step of determining the shortest path from a staring vertex to a destination vertex comprising:
determining the shortest path from the staring vertex to the destination vertex by a topological sorting method.

5. The method of claim 4, the step of determining the shortest path from the staring vertex to the destination vertex by a topological sorting method comprising:
determining a value of a visiting vertex of the start vertex, wherein, the visiting vertex is connected to the start vertex through an output edge of the start vertex at step S1;
determining the visiting vertex without an unvisited input edge as a current vertex at step S2;
determining a value of a visiting vertex of the current vertex at step S3, wherein the visiting vertex is connected to the current vertex through an output edge of the current vertex; and
repeating the step S2 and S3 until all vertices have been visited and there are no unvisited edges.

6. The method of claim 5, further comprising: an initial value of the starting vertex is set to 0 and an initial value of the non-starting vertex is set to a large value.

7. The method of claim 5, the step of determining a value of a visiting vertex of the current vertex comprising:
adding the value of the edge from the current vertex to the visiting vertex and a current value of the current vertex to obtain a sum value;
updating the current value of the visiting vertex to the sum value if the sum value is smaller than the current value of the visiting vertex; and
keeping the current value of the visiting vertex unchanged if the sum value is not smaller than the current value of the visiting vertex.

8. The method of claim 1, wherein the shortest path represents the path from the starting vertex to the destination vertex on which the sum of the values of the edges in the path is smallest.

9. The method of claim 3, wherein the value of the vertex Vᵢ is used for indicating the total amount of DRAM access from the input of fusion₀ to the output of fusionᵢ₋₁.

10. The method of claim 3, converting a portion of the machine learning model corresponding to an operation requirement of a hardware into a directed acyclic graph comprising:
building the plurality of vertices with sequential numbers, wherein the number of the vertices is equal to the number of fusions in the portion of the machine learning model plus one;
building a directed base edge between two vertices with adjacent numbers, wherein the directed base edge is set to indicate a total amount of DRAM accesses of the corresponding single fusion; and
building a directed direct edge between two vertices with non-adjacent numbers, wherein the directed direct edge is set to indicate a total amount of DRAM accesses from an input of one fusion to an output of another fusion, and the data that needs to be transferred between the fusions in a fusion set from the one fusion to another fusion is not stored in the DRAM.

11. The method of claim 10, wherein the data that needs to be transferred between the fusions in a fusion set from the one fusion to another fusion is stored in a cache.

12. The method of claim 10, further comprising:
determining whether the directed direct edge is built is based on a capacity of the cache;
wherein if the cache has the capacity to store the data that needs to be transferred between the fusions in the fusion set from one fusion to another fusion, then the directed direct edge is built; if the cache does not have the capacity to store the data that needs to be transferred between the fusions in a fusion set from one fusion to another fusion, then the directed direct edge is not built.

13. A device, comprising:
a processor; and
a memory storing instructions, wherein the instructions are performed by the processor to perform:
convert a portion of a machine learning model corresponding to an operation requirement of a hardware into a directed acyclic graph, wherein the portion of the machine learning model comprises multiple fusions, and the directed acyclic graph comprises a plurality of vertices and a plurality of directed edges, wherein an edge e_{i,j} is from a vertex Vᵢ to a vertex Vⱼ, and a value of the edge e_{i,j} is set to indicate a total amount of an external memory accesses from an input of fusionᵢ to an output of fusionⱼ₋₁, where i, j are positive integers and j is larger than i, and wherein the external memory is located outside of the hardware; and
determine a shortest path, wherein the shortest path is from a starting vertex to a destination vertex with a smallest total amount of external memory accesses, wherein the starting vertex does not have an input edge, and the destination vertex does not have an output edge.

14. The device of claim 13, wherein the edge e_{i,j} is used for indicating data that needs to be transferred between fusions in a fusion set from fusionᵢ to fusionⱼ₋₁ is stored in a cache, rather than the external memory, when j−1 is larger than i.

15. The device of claim 13, wherein the external memory is a DRAM (dynamic random access memory).

16. The device of claim 13, wherein the processor is configured to determine the shortest path from the starting vertex to the destination vertex by using a topological sorting method.

17. The device of claim 16, wherein the processor is further configured to:
update a value of a visiting vertex of the starting vertex, wherein the visiting vertex is connected to the starting vertex through an output edge of the starting vertex;
determine the visiting vertex without an unvisited input edge as a current vertex; and
determine a value of a visiting vertex of the current vertex, wherein the visiting vertex is connected to the current vertex through an output edge of the current vertex, and
repeating the step of determining the visiting vertex without an unvisited input edge as a current vertex and the step of determining a value of a visiting vertex of the current vertex until all vertices have been visited and there are no unvisited edges.

18. The device of claim 17, wherein the processor is further configured to set an initial value of the starting vertex to 0, and an initial value of a non-starting vertex to a large value.

19. The device of claim 17, wherein in determining a value of a visiting vertex of the current vertex, the processor is configured to perform:
a value of an edge from the current vertex to the visiting vertex is added to a current value of the current vertex to obtain a sum value;
a current value of the visiting vertex is updated to the sum value if the sum value is smaller than the current value of the visiting vertex; and
the current value of the visiting vertex is retained if the sum value is not smaller than the current value of the visiting vertex.

20. The device of claim 13, wherein the shortest path represents a path from the starting vertex to the destination vertex on which a sum of values of edges in the path is smallest.
